(19) United States
(12) Patent Application Publication
(10) Pub. No.: US 2022/0200827 A1
(43) Pub. Date: Jun. 23, 2022

(54) Asymmetric Optical Communication Architecture

(71) Applicant: Rafael Microelectronics, Inc., Hsinchu County (TW)

(72) Inventors: Chia-Hsiou CHEN, Hsinchu County (TW); Meng-Ping KAN, Hsinchu County (TW); Chun-An HSIEH, Hsinchu County (TW)

(21) Appl. No.: 17/127,898

(22) Filed: Dec. 18, 2020

(51) Int. Cl. H04L 25/03; H04L 25/02; H04B 10/40

(52) U.S. Cl. CPC H04L 25/03885; H04L 25/03057; H04B 10/40; H04L 25/03343; H04L 25/0272

(57) ABSTRACT

A single-chip integrated circuit is disclosed, wherein the single-chip integrated circuit comprises at least one unidirectional communication channel for converting a first electrical signal to a first optical signal and at least one bidirectional communication channel for converting a second electrical signal to a second optical signal and converting a third optical signal to a third electrical signal.

### BACKGROUND OF THE INVENTION

### 1. Field of the Invention

The invention relates to an optical communication circuit, and in particular, but not exclusively, to an optical communication circuit with asymmetric optical communication architecture.

### 2. Description of the Prior Art

In recent years, optical fiber has been widely used for transmitting video signals or other high data rate signals. However, conventional cable uses copper wire to transfer video data or control data, which has limited bandwidth and is susceptible to noise or interference.

Accordingly, the present invention proposes a better solution to overcome the above-mentioned problems.

### SUMMARY OF THE INVENTION

One objective of the present invention is to provide a single-chip integrated circuit with asymmetric optical Communication architecture to provide cost effective and power efficient solution for AOC (Active Optical Cable) applications.

The present invention discloses a single-chip integrated circuit, comprising: at least one first unidirectional communication channel, wherein the first unidirectional communication channel comprises a first sub-circuit for converting a first electrical signal to a first optical signal; and at least one first bidirectional communication channel, wherein the first bidirectional communication channel comprises a second sub-circuit for converting a second electrical signal to a second optical signal and a third sub-circuit for converting a third optical signal to a third electrical signal.

In one embodiment, the first unidirectional communication channel is used for transmitting video data and the first bidirectional communication channel is used for transmitting and receiving control data associated with the video data.

In one embodiment, the first electrical signal is a single-ended signal.

In one embodiment, the first electrical signal is a pair of differential signals.

In one embodiment, the second electrical signal is a single-ended signal.

In one embodiment, the second electrical signal is a pair of differential signals.

In one embodiment, the third electrical signal is a single-ended signal.

In one embodiment, the third electrical signal is a pair of differential signals.

In one embodiment, the pair of differential signals is a TMDS (Time Minimized Differential Signal).

In one embodiment, an optical diode used to convert the first electrical signal to the first optical signal is outside the single-chip integrated circuit.

In one embodiment, an optical diode used to convert the first electrical signal to the first optical signal is inside the single-chip integrated circuit.

In one embodiment, an optical diode used to convert the second electrical signal to the second optical signal is outside the single-chip integrated circuit.

In one embodiment, an optical diode used to convert the second electrical signal to the second optical signal is inside the single-chip integrated circuit.

In one embodiment, a photo diode used to convert the third optical signal to the third electrical signal is outside the single-chip integrated circuit.

In one embodiment, a photo diode used to convert the third optical signal to the third electrical signal is inside the single-chip integrated circuit.

In one embodiment, the first unidirectional communication channel is used for transmitting High Definition Multimedia Interface (HDMI) video data and the at least one bidirectional communication channel is used for transmitting and receiving control data associated with the HDMI video data.

In one embodiment, the first unidirectional communication channel is used for transmitting Display Port (DP) video data and the at least one bidirectional communication channel is used for transmitting and receiving control data associated with the DP video data.

In one embodiment, each of the second electrical signal and the third electrical signal is based on USB standard.

In one embodiment, the single-chip integrated circuit is based on CMOS technology.

In one embodiment, the single-chip integrated circuit comprises a plurality of unidirectional communication channels, wherein each unidirectional communication channel comprises a corresponding sub-circuit for converting a corresponding electrical signal to a corresponding optical signal.

In one embodiment, the single-chip integrated circuit comprises a plurality of bidirectional communication channels, wherein each bidirectional communication channel comprises a corresponding sub-circuit for converting a corresponding electrical signal to a corresponding optical signal and a corresponding third sub-circuit for converting a corresponding optical signal to a corresponding electrical signal.

The present invention discloses a single-chip integrated circuit, comprising: at least one first unidirectional communication channel, wherein the first unidirectional communication channel comprises a first sub-circuit for converting a corresponding optical signal to a corresponding electrical signal; and at least one first bidirectional communication channel, wherein the first bidirectional communication channel comprises a second sub-circuit for converting a corresponding electrical signal to a corresponding optical signal and a third sub-circuit for converting a corresponding optical signal to a corresponding electrical signal.

In one embodiment, a photo diode used to convert the first optical signal to the first electrical signal is outside the single-chip integrated circuit.

In one embodiment, a photo diode used to convert the first optical signal to the first electrical signal is inside the single-chip integrated circuit.

In one embodiment, an optical diode used to convert the second electrical signal to the second optical signal is outside the single-chip integrated circuit.

In one embodiment, an optical diode used to convert the second electrical signal to the second optical signal is inside the single-chip integrated circuit.

In one embodiment, a photo diode used to convert the third optical signal to the third electrical signal is outside the single-chip integrated circuit.

In one embodiment, a photo diode used to convert the third optical signal to the third electrical signal is inside the single-chip integrated circuit.

In one embodiment, the first unidirectional communication channel is used for receiving video data and the first bidirectional communication channel is used for transmitting and receiving control data associated with the video data.

In one embodiment, the first unidirectional communication channel is used for receiving HDMI video data and the at least one bidirectional communication channel is used for transmitting and receiving control data associated with the HDMI video data.

In one embodiment, the first unidirectional communication channel is used for receiving DP video data and the at least one bidirectional communication channel is used for transmitting and receiving control data associated with the DP video data.

In one embodiment, each of the second electrical signal and the third electrical signal is based on USB standard.

In one embodiment, the single-chip integrated circuit is based on CMOS technology.

The present invention discloses a circuit with asymmetric optical communication architecture, comprising: at least one first unidirectional communication channel, wherein the first unidirectional communication channel comprises a first sub-circuit for converting a first electrical signal to a first optical signal; and at least one first bidirectional communication channel, wherein the first bidirectional communication channel comprises a second sub-circuit for converting a second electrical signal to a second optical signal and a third sub-circuit for converting a third optical signal to a third electrical signal, wherein the first unidirectional communication channel is used for transmitting video data and the first bidirectional communication channel is used for transmitting and receiving control data associated with the video data.

In one embodiment, the circuit comprises a plurality of unidirectional communication channels and a plurality of bidirectional communication channels, wherein each unidirectional communication channel comprises a corresponding sub-circuit for converting a corresponding electrical signal to a corresponding optical signal, and wherein each bidirectional communication channel comprises a corresponding sub-circuit for converting a corresponding electrical signal to a corresponding optical signal and a corresponding third sub-circuit for converting a corresponding optical signal to a corresponding electrical signal.

The present invention discloses a communication system, comprising: a first single-chip integrated circuit, comprising: at least one first unidirectional communication channel, wherein each unidirectional communication channel comprises a first sub-circuit for converting a corresponding electrical signal to a corresponding optical signal; and at least one first bidirectional communication channel, wherein each bidirectional communication channel comprises a corresponding second sub-circuit for converting a corresponding electrical signal to a corresponding optical signal and a third sub-circuit for converting a corresponding optical signal to a corresponding electrical signal; and a second single-chip integrated circuit, comprising: at least one second unidirectional communication channel, wherein each unidirectional communication channel comprises a first sub-circuit for converting a corresponding optical signal to a corresponding electrical signal; and at least one second bidirectional communication channel, wherein each bidirectional communication channel comprises a corresponding second sub-circuit for converting a corresponding electrical signal to a corresponding optical signal and a third sub-circuit for converting a corresponding optical signal to a corresponding electrical signal; wherein the first single-chip integrated circuit and the second single-chip integrated circuit are connected by optical fibers.

The detailed technology and above preferred embodiments implemented for the present invention are described in the following paragraphs accompanying the appended drawings for people skilled in this field to well appreciate the features of the claimed invention.

### BRIEF DESCRIPTION OF DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a single-chip integrated circuit with asymmetric optical communication architecture in accordance with one embodiment of the present invention;

FIG. 1B illustrates a single-chip integrated circuit with asymmetric optical communication architecture in accordance with one embodiment of the present invention;

FIG. 1C illustrates a sub-circuit of the unidirectional communication channel of FIG. 1A in accordance with one embodiment of the present invention;

FIG. 1D illustrates a sub-circuit of the bidirectional communication channel of FIG. 1A in accordance with one embodiment of the present invention;

FIG. 2 illustrates one example of the single chip in FIG. 1A in accordance with one embodiment of the present invention;

FIG. 3A illustrates a single-chip integrated circuit with asymmetric optical communication architecture in accordance with another embodiment of the present invention;

FIG. 3B illustrates a single-chip integrated circuit with asymmetric optical communication architecture in accordance with another embodiment of the present invention;

FIG. 3C illustrates a sub-circuit of unidirectional communication channel of FIG. 3A in accordance with one embodiment of the present invention;

FIG. 3D illustrates a sub-circuit of bidirectional communication channel of FIG. 3A in accordance with one embodiment of the present invention;

FIG. 4 illustrates one example of the single chip in FIG. 3A in accordance with one embodiment of the present invention;

FIG. 5 illustrates an example of a communication system using the single-chip integrated circuit in FIG. 1A and the single-chip integrated circuit in FIG. 3A;

FIG. 6 illustrates an example of a communication system using the single-chip integrated circuit in FIG. 1A and the single-chip integrated circuit in FIG. 3A;

FIG. 7 illustrates an example of a communication system using the single-chip integrated circuit in FIG. 1A and the single-chip integrated circuit in FIG. 3A;

FIG. 8 illustrates an example of a communication system using the single-chip integrated circuit in FIG. 1A and the single-chip integrated circuit in FIG. 3A; and

FIG. 9 illustrates an example of a communication system using the single-chip integrated circuit in FIG. 1A and the single-chip integrated circuit in FIG. 3A.

### DETAILED DESCRIPTION OF EMBODIMENT

The detailed explanation of the present invention is described as following. The described preferred embodiments are presented for purposes of illustrations and description, and they are not intended to limit the scope of the present invention.

HDMI and DP interface grows together with USB 3.1/3.2. HDMI 2.1 AOC (Active Optical Cable) is required for 4K display when the distance is longer than 5 meters and 8K display when the distance is longer than 1 meter. AOC can overcome long distance video display applications. Combination of HDMI/DP and USB optical cable is suitable for emerging applications like VR headset or NB docking stations.

HDMI active optical cable (AOC) provides fast and high-quality video for various applications for indoor/outdoor digital signage, 4K/8K TV, medical image display, or gaming console applications.

A single-chip integrated circuit with asymmetric optical communication architecture of the present invention can provide a cost effective and power efficient solution for AOC industry.

### First Embodiment

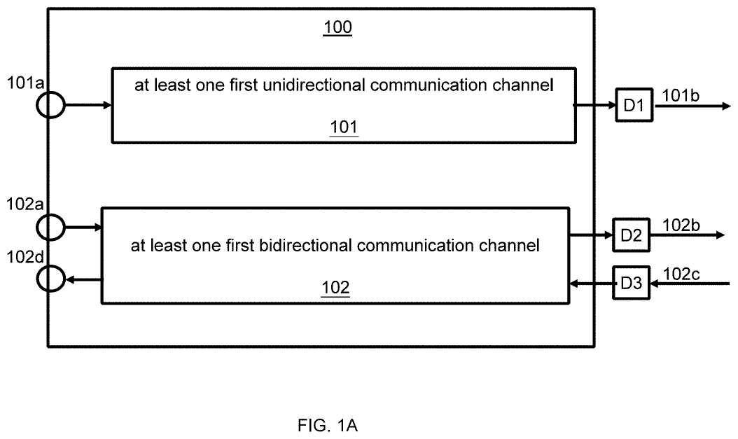

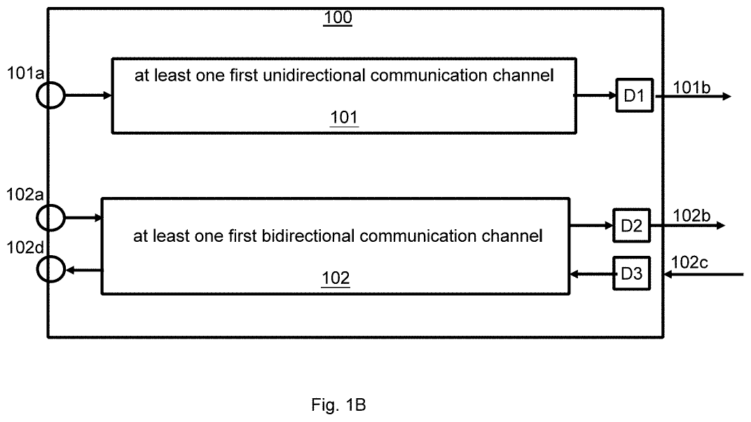

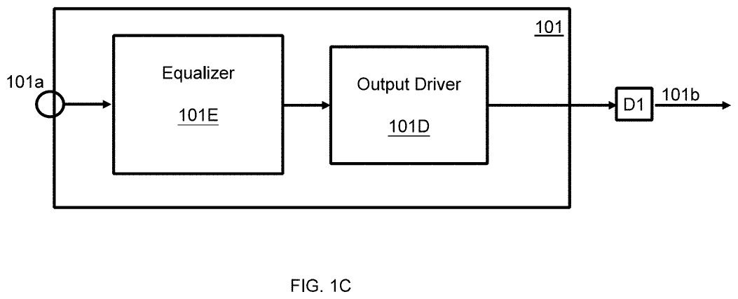

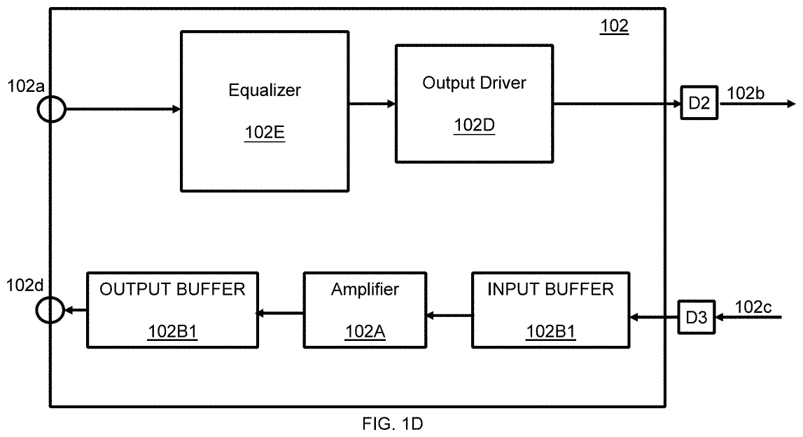

FIG. 1A illustrates a single-chip integrated circuit 100 with asymmetric optical communication architecture, wherein single-chip integrated circuit 100 comprises: at least one first unidirectional communication channel 101, wherein the first unidirectional communication channel 101 comprises a first sub-circuit for converting a first electrical signal 101a to a first optical signal 101b; and at least one first bidirectional communication channel 102, wherein the first bidirectional communication channel comprises a second sub-circuit for converting a second electrical signal 102a to a second optical signal 102b and a third sub-circuit for converting a third optical signal 102c to a third electrical signal 102d.

In one embodiment, the first electrical signal 101a is a single-ended signal, wherein a pin of the single-chip integrated circuit 100 is used for inputting the first electrical signal 101a.

In one embodiment, the first electrical signal 101a is a pair of differential signals, wherein two pins of the single-chip integrated circuit 100 are used for inputting the pair of differential signals.

In one embodiment, the second electrical signal 102a is a single-ended signal, wherein a pin of the single-chip integrated circuit 100 is used for inputting the second electrical signal 102a.

In one embodiment, the second electrical signal 102a is a pair of differential signals, wherein two pins of the single-chip integrated circuit 100 are used for inputting the pair of differential signals.

In one embodiment, the third electrical signal 102d is a single-ended signal, wherein a pin of the single-chip integrated circuit 100 is used for outputting the third electrical signal 102d.

In one embodiment, the third electrical signal 102d is a pair of differential signals, wherein two pins of the single-chip integrated circuit 100 are used for outputting the pair of differential signals.

In one embodiment, the pair of differential signals is based on TMDS (Time Minimized Differential Signal) and conformed to HDMI standard.

In one embodiment, the pair of differential signals is based on TMDS (Time Minimized Differential Signal) and conformed to DP standard.

In one embodiment, each of the second electrical signal 102a and the third electrical signal 102d is a single-ended signal.

In one embodiment, wherein each of the second electrical signal 102a and the third electrical signal 102d is a pair of differential signals.

In one embodiment, the second electrical signal 102a and the third electrical signal 102d are based on USB standard.

In one embodiment, an optical diode D1, such as a laser diode, is used for converting the first electrical signal 101a to the first optical signal 101b.

In one embodiment, as shown in FIG. 1A, the optical diode D1 is outside of the single-chip integrated circuit 100.

In one embodiment, as shown in FIG. 1B, the optical diode D1 is inside of the single-chip integrated circuit 100.

In one embodiment, the optical diode D1 is a VCSEL (Vertical Cavity Surface Emitting Laser) diode.

In one embodiment, an optical diode D2, such as a laser diode, is used for converting the second electrical signal 102a to the second optical signal 102b and a photo diode D3 is used for converting the third optical signal 102c to the third electrical signal 102d.

In one embodiment, the optical diode D2 is a VCSEL (Vertical Cavity Surface Emitting Laser) diode.

In one embodiment, as shown in FIG. 1A, the diodes D2 and D3 are outside of the integrated circuit 100.

In one embodiment, as shown in FIG. 1B, the diodes D2 and D3 are inside of the integrated circuit 100.

In one embodiment, the at least one unidirectional communication channel 101 is used for transmitting video data and the at least one bidirectional communication channel 102 is used for transmitting and receiving control data associated with the video data.

In one embodiment, the at least one unidirectional communication channel 101 is used for transmitting HDMI video data and the at least one bidirectional communication channel 102 is used for transmitting and receiving HDMI control data associated with the HDMI video data.

In one embodiment, the at least one unidirectional communication channel 101 is used for transmitting DP video data and the at least one bidirectional communication channel 102 is used for transmitting and receiving DP control data associated with the DP video data.

In one embodiment, the single-chip integrated circuit 100 is based on CMOS technology.

In one embodiment, the single-chip integrated circuit 100 comprises a plurality of unidirectional communication channels, wherein each unidirectional communication channel comprises a corresponding sub-circuit for converting a corresponding electrical signal to a corresponding optical signal.

In one embodiment, the single-chip integrated circuit 100 comprises a plurality of bidirectional communication channels, wherein each bidirectional communication channel comprises a corresponding sub-circuit for converting a corresponding electrical signal to a corresponding optical signal and a corresponding sub-circuit for converting a corresponding optical signal to a corresponding electrical signal.

In one embodiment, each unidirectional communication channel 101 transmits 12 Gbps signal.

In one embodiment, each unidirectional communication channel 101 transmits 6 Gbps signal.

In one embodiment, each bidirectional communication channel 102 transmits and receives 480 Mbps signal.

In one embodiment, each bidirectional communication channel 102 transmits and receives 10 Gbps signal.

In one embodiment, each bidirectional communication channel 102 transmits and receives 20 Gbps signal.

In one embodiment, the single-chip integrated circuit 100 comprises four unidirectional communication channels and one bidirectional communication channel.

In one embodiment, the single-chip integrated circuit 100 comprises four unidirectional communication channels and two bidirectional communication channels.

In one embodiment, as shown in FIG. 1C, the first unidirectional communication channel 101 comprises a first equalizer 101E and a first output driver 101D, wherein the first electrical signal 101a is coupled to an input of the first equalizer 101E and an output of the first equalizer 101E is coupled to an input of the first output driver 101D, wherein the first output driver 101D is coupled to a first optical diode D1 to generate the first optical signal 101b.

In one embodiment, as shown in FIG. 1D, the first bidirectional communication channel 102 comprises a first equalizer 102E and a first output driver 102D, wherein the first electrical signal 102a is coupled to an input of the first equalizer 102E and an output of the first equalizer 102E is coupled to an input of the first output driver 102D, wherein the first output driver 102D is coupled to a second optical diode D2 to generate the second optical signal 102b.

In one embodiment, as shown in FIG. 1D, the first bidirectional communication channel 102 comprises an amplifier 102A, wherein an input of the amplifier 102A is coupled to a fourth electrical signal that is generated by the optical diode D3 in response to the third optical signal 102c, and an output of the amplifier 102A is coupled to the third electrical signal 102d.

In one embodiment, as shown in FIG. 1D, the first bidirectional communication channel 102 further comprises an input buffer 102B1 and an output buffer 102B2, wherein an input of the input buffer 102B1 is coupled to the fourth electrical signal generated by the optical diode D3 in response to the third optical signal 102c, and an output of the input buffer 102B1 is coupled to the input of the amplifier 102A, wherein an input of the output buffer 102B2 is coupled to the output of the amplifier 102A, and an output of the output buffer 102A is coupled to the third electrical signal 102d.

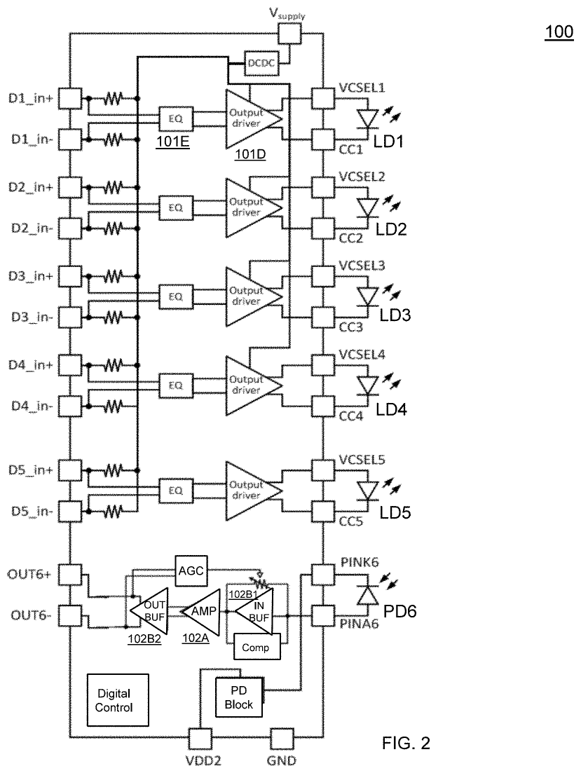

FIG. 2 illustrates an example of the single-chip integrated circuit 100, wherein the first unidirectional communication channel receives a pair of differential signals D1_in⁺, D1_in⁻ that is coupled to a first equalizer 101E, wherein the first equalizer 101E is inputted to a first output driver 101D and the first output driver 101D outputs a first pair of differential signal VCSEL1, CC1 to drive a first laser diode LD1; the second unidirectional communication channel receives a second pair of differential signals D2_in⁺, D2_in⁻ that is coupled to a second equalizer, wherein the second equalizer is inputted to a second output driver and the second output driver outputs a second pair of differential signal VCSEL2, CC2 to drive a second laser diode LD2; the third unidirectional communication channel receives a third pair of differential signals D3_in⁺, D3_in⁻ that is coupled to a third equalizer, wherein the third equalizer is inputted to a third output driver and the third output driver outputs a third pair of differential signal VCSEL3, CC3 to drive a third laser diode LD3; the fourth unidirectional communication channel receives a fourth pair of differential signals D4_in⁺, D4_in⁻ that is coupled to a fourth equalizer, wherein the fourth equalizer is inputted to a fourth output driver and the fourth output driver outputs a fourth pair of differential signal VCSEL4, CC4 to drive a fourth laser diode LD4. The first bidirectional communication channel receives a pair of differential signals D5_in⁺, D5_in⁻ that is coupled to a fifth equalizer, wherein the fifth equalizer is inputted to a fifth output driver and the fifth output driver outputs a fifth pair of differential signal VCSEL5, CC5 to drive a fifth laser diode LD5; the first bidirectional communication channel receives a pair of differential signals PINK6, PINA6 that is generated form the photo diode PD6 and coupled to an input buffer, wherein the input buffer 102B1 is inputted to an input of an amplifier 102A and an output of the amplifier 102A is inputted to an output buffer 102B2, wherein the output buffer 102B2 outputs a sixth pair of differential signals D6_in⁺, D6_in⁻.

In one embodiment, each of the laser diodes D1, D2, D3, D4, D5 is a VCSEL (Vertical Cavity Surface Emitting Laser) diode.

The single-chip integrated circuit in FIG. 2 is based on CMOS technology.

### Second Embodiment

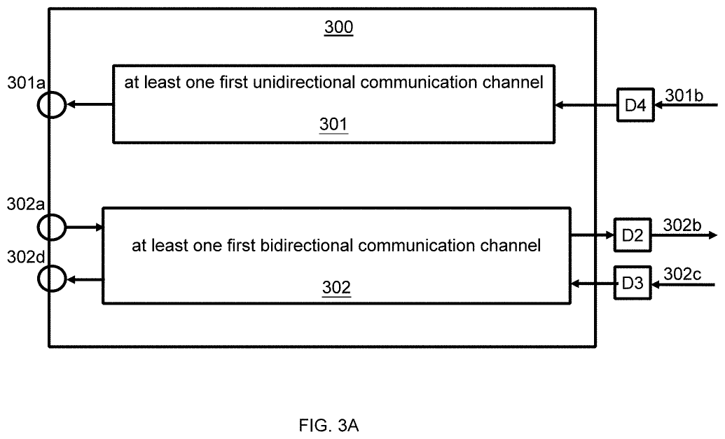

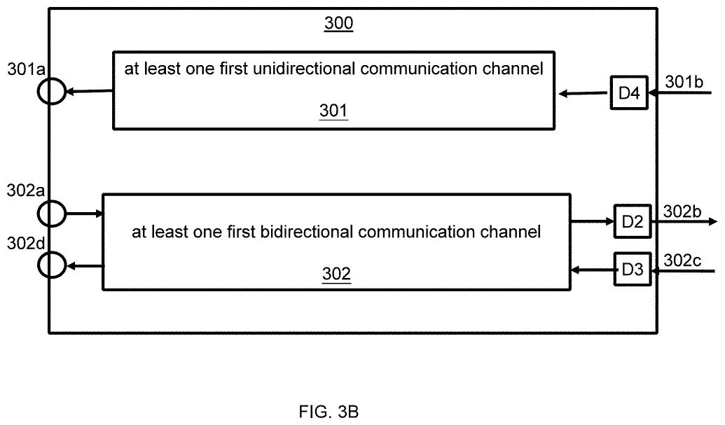

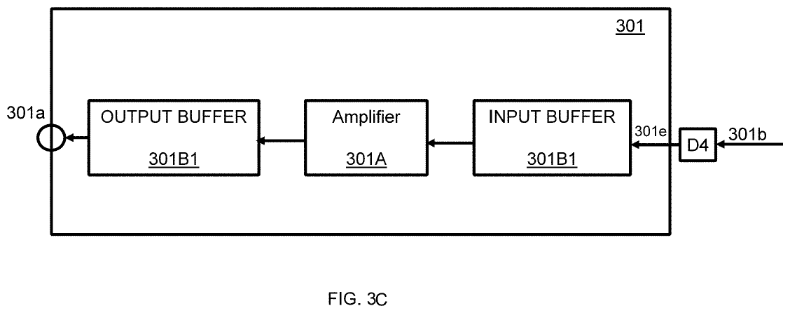

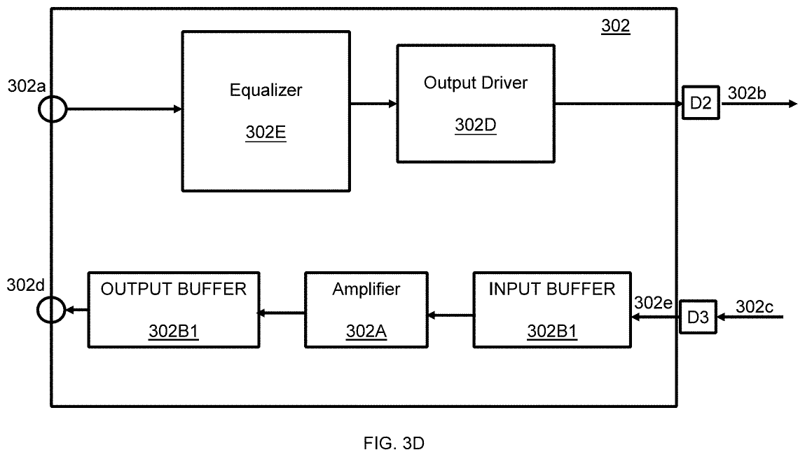

FIG. 3A illustrates a single-chip integrated circuit 300, wherein single-chip integrated circuit 300 comprises: at least one first unidirectional communication channel 301, wherein the first unidirectional communication channel 301 comprises a first sub-circuit for converting a first optical signal 301b to a first electrical signal 301a; and at least one first bidirectional communication channel 302, wherein the first bidirectional communication channel comprises a second sub-circuit for converting a second electrical signal 302a to a second optical signal 302b and a third sub-circuit for converting a third optical signal 302c to a third electrical signal 302d.

In one embodiment, a pin of the single-chip integrated circuit 300 is used for outputting the first electrical signal 301a, wherein the first electrical signal 301a is a single-ended signal.

In one embodiment, the first electrical signal 301a is a pair of differential signals, wherein two pins of the single-chip integrated circuit 300 are used for outputting the pair of differential signals.

In one embodiment, the pair of differential signals is based on TMDS (Time Minimized Differential Signal) and conformed to HDMI standard.

In one embodiment, the pair of differential signals is based on TMDS (Time Minimized Differential Signal) and conformed to DP standard.

In one embodiment, the second electrical signal 302a and the third electrical signal 302d are based on USB standard.

In one embodiment, each of the second electrical signal 302a and the third electrical signal 302d is a single-ended signal.

In one embodiment, wherein each of the second electrical signal 302a and the third electrical signal 302d is a pair of differential signals.

In one embodiment, as shown in FIG. 3A, a photo diode D4 used for converting the first optical signal 301b to the first electrical signal 301a is outside of the single-chip integrated circuit 300.

In one embodiment, as shown in FIG. 3B, the photo diode D4 used for converting the first optical signal 301b to the first electrical signal 301a is inside of the single-chip integrated circuit 300.

In one embodiment, an optical diode D2, such as a laser diode, is used for converting the second electrical signal 302a to the second optical signal 302b and a photo diode D3 is used for converting the third optical signal 302c to the third electrical signal 302d.

In one embodiment, the optical diode D2 is a VCSEL (Vertical Cavity Surface Emitting Laser) diode.

In one embodiment, as shown in FIG. 3A, the diodes D2 and D3 are outside of the integrated circuit 300.

In one embodiment, as shown in FIG. 3B, the diodes D2 and D3 are inside of the integrated circuit 300.

In one embodiment, the first unidirectional communication channel is used for transmitting video data and the first bidirectional communication channel is used for transmitting and receiving control data associated with the video data.

In one embodiment, the at least one unidirectional communication channel is used for transmitting HDMI video data and the at least one bidirectional communication channel is used for transmitting and receiving HDMI control data associated with the HDMI video data.

In one embodiment, the at least one unidirectional communication channel is used for transmitting DP video data and the at least one bidirectional communication channel is used for transmitting and receiving DP control data associated with the DP video data.

In one embodiment, the single-chip integrated circuit 300 is based on CMOS technology.

In one embodiment, the single-chip integrated circuit 300 comprises a plurality of unidirectional communication channels.

In one embodiment, the single-chip integrated circuit 300 comprises a plurality of bidirectional communication channels.

In one embodiment, the unidirectional communication channel 301 receives 12 Gbps optical signal.

In one embodiment, the unidirectional communication channel 301 receives 6 Gbps optical signal.

In one embodiment, the bidirectional communication channel 302 transmits and receives 480 Mbps optical signal.

In one embodiment, the bidirectional communication channel 302 transmits and receives 10 Gbps optical signal.

In one embodiment, the bidirectional communication channel 302 transmits and receives 20 Gbps optical signal.

In one embodiment, the single-chip integrated circuit 300 comprises four unidirectional communication channels and one bidirectional communication channel.

In one embodiment, the single-chip integrated circuit 300 comprises four unidirectional communication channels and two bidirectional communication channels.

In one embodiment, as shown in FIG. 3C, the first unidirectional communication channel 301 comprises an amplifier 301A, wherein an input of the amplifier 301A is coupled to a fourth electrical signal 301e that is generated by a photo diode D4 in response to the first optical signal 301b, and an output of the amplifier 301A is coupled to the first electrical signal 301a.

In one embodiment, as shown in FIG. 3C, the first bidirectional communication channel 301 further comprises an input buffer 301B1 and an output buffer 301B2, wherein an input of the input buffer 301B1 is coupled to the fourth electrical signal 301e that is generated by the photo diode D4 in response to the first optical signal 301b, and an output of the input buffer 301B1 is coupled to the input of the amplifier 301A, wherein an input of the output buffer 301B2 is coupled to the output of the amplifier 301A, and an output of the output buffer 301B2 is coupled to first electrical signal 301a.

In one embodiment, as shown in FIG. 3D, the first bidirectional communication channel 302 comprises a first equalizer 302E and a first output driver 302D, wherein the first electrical signal 302a is coupled to an input of the first equalizer 302E and an output of the first equalizer 302E is coupled to an input of the first output driver 302D, wherein the first output driver 302D is coupled to a second optical diode D2 to generate the second optical signal 302b.

In one embodiment, as shown in FIG. 3D, the first bidirectional communication channel 302 comprises an amplifier 302A, wherein an input of the amplifier 302A is coupled to an electrical signal 302e that is generated by the photo diode D3 in response to the third optical signal 302c, and an output of the amplifier 302A is coupled to the third electrical signal 302d.

In one embodiment, as shown in FIG. 3D, the first bidirectional communication channel 302 further comprises an input buffer 302B1 and an output buffer 302B2, wherein an input of the input buffer 302B1 is coupled to the electrical signal 302e that is generated by the photo diode D3 in response to the third optical signal 302c, and an output of the input buffer 302B1 is coupled to the input of the amplifier 302A, wherein an input of the output buffer 302B2 is coupled to the output of the amplifier 302A, and an output of the output buffer 302A is coupled to the third electrical signal 302d.

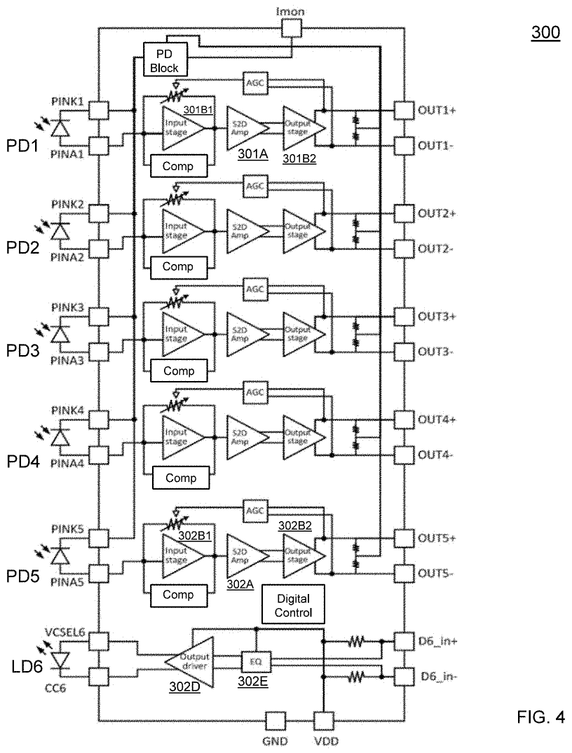

FIG. 4 illustrates an example of the single-chip integrated circuit 300, wherein the first unidirectional communication channel receives a pair of differential signals PINK1, PINA1 generated form the photo diode PD1 and coupled to an input buffer 301B1, wherein the input buffer 301B1 is inputted to an input of an amplifier 301A and an output of the amplifier 301A is inputted to an output buffer 301B2, wherein the output buffer 301B2 outputs a pair of differential signals out1⁺, out1⁻; the second unidirectional communication channel receives a pair of differential signals PINK2, PINA2 generated form the photo diode PD2 and coupled to an input buffer, wherein the input stage buffer is inputted to an input of an amplifier and an output of the amplifier is inputted to an output buffer, wherein the output buffer outputs a pair of differential signals out2⁺, out2; the third unidirectional communication channel receives a pair of differential signals PINK3, PINA3 generated form the photo diode PD3 and coupled to an input buffer, wherein the input stage is inputted to an input of an amplifier and an output of the amplifier is inputted to an output buffer, wherein the output buffer outputs a pair of differential signals out3⁺, out3; the fourth unidirectional communication channel receives a fourth pair of differential signals PINK4, PINA4 generated form the photo diode PD4 and coupled to an input buffer, wherein the input buffer is inputted to an input of an amplifier and an output of the amplifier is inputted to an output buffer, wherein the output buffer outputs a pair of differential signals out4⁺, out4. The first bidirectional communication channel receives a pair of differential signals PINK5, PINA5 generated form the photo diode PD5 and coupled to an input buffer 302B1, wherein the input buffer 302B1 is inputted to an input of an amplifier 302A and an output of the amplifier 302A is inputted to an output buffer 302B2, wherein the output buffer 302B2 outputs a pair of differential signals out5⁺, out5⁻; the first bidirectional communication channel receives a pair of differential signals D6_in⁺, D6_in⁻ that is coupled to an equalizer 302E, wherein the equalizer 302E is inputted to an output driver 302D and the output driver 302D outputs a pair of differential signal VCSEL6, CC6 to drive the laser diode LD6.

In one embodiment, each laser diode LD1, LD2, LD3, LD4, LD6 is a VCSEL (Vertical Cavity Surface Emitting Laser) diode.

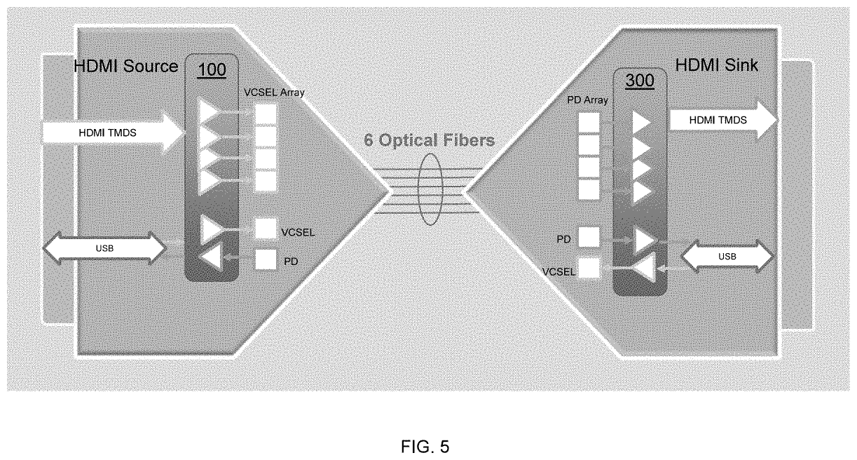

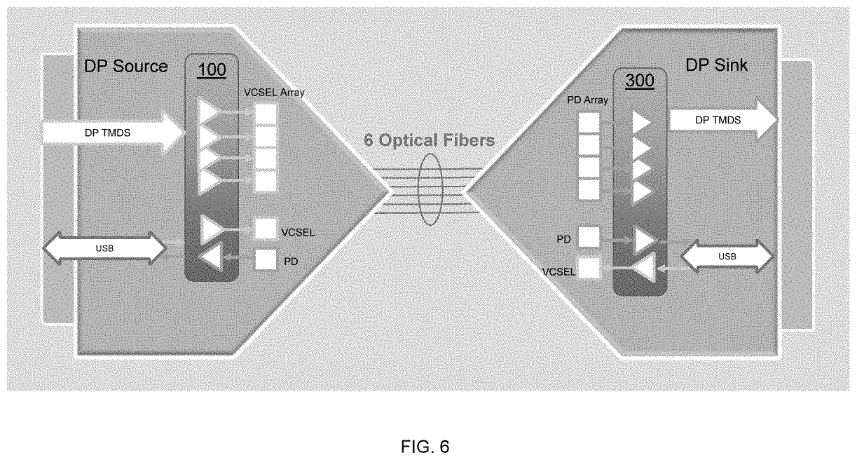

FIG. 5 illustrates an example of a communication system using the single-chip integrated circuit 100 and the single-chip integrated circuit 300, wherein the single-chip integrated circuit 100 and the single-chip integrated circuit 300 are connected by six fibers, wherein the four unidirectional channel of the single-chip integrated circuit 100 are used for transmitting HDMI TMDS video, and the four unidirectional channel of the single-chip integrated circuit 300 are used for receiving the HDMI TMDS video. The USB bidirectional channel of the single-chip integrated circuit 100 and the USB bidirectional channel of the single-chip integrated circuit 300 are used for transmitting and receiving control data associated with the HDMI TMDS video data. The four unidirectional HDMI TMDS channels can be 4×6 Gbps (HDMI 2.0) or 4×12 Gbps (HDMI 2.1). The USB bidirectional channel can be 1×480 Mbps (USB 2) or 1×10 G bps (USB 3) or 1×20 G bps (USB 4). The advantages of FIG. 6 includes: Low cost AOC with minimum VCSEL/PD chip count, designed for cost effective 6 fiber cable application, free from EMI interference, high bandwidth, low signal loss, which is suitable for applications such as NB docking station, high speed light weight VR headset or gaming console connection.

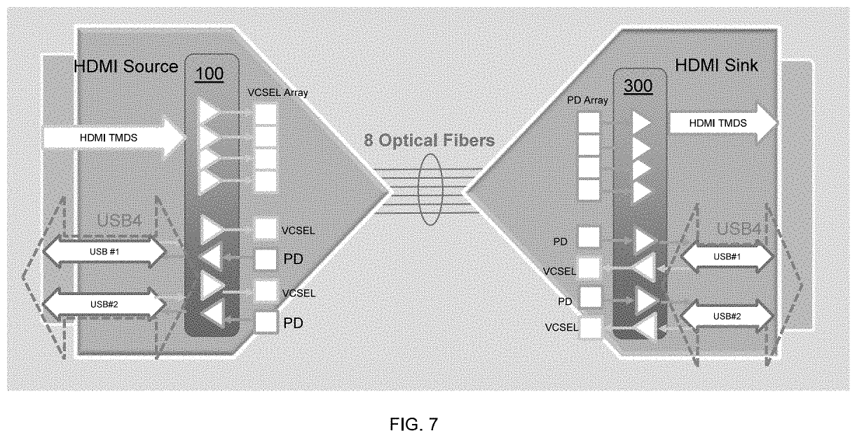

FIG. 6 illustrates an example of a communication system using the single-chip integrated circuit 100 and the single-chip integrated circuit 300, wherein the single-chip integrated circuit 100 and the single-chip integrated circuit 300 are connected by six fibers, wherein the four DP TMDS unidirectional channel of the single-chip integrated circuit 100, are used for transmitting DP video data, and the four DP TMDS unidirectional channel of the single-chip integrated circuit 300 are used for receiving the DP video data. the USB bidirectional channel of the single-chip integrated circuit 100 and the USB bidirectional channel of the single-chip integrated circuit 300 are used for transmitting and receiving control data associated with the DP video data. The four DP TMDS unidirectional channels can be 8.1 Gbps (DP1.4) or 4×20 Gbps (DP2.0). The USB bidirectional channel can be 1×480 Mbps (USB 2) or 1×10 G bps (USB 3) or 1×20 G bps (USB 4). The advantages of the communication system in FIG. 7 includes: low cost AOC with minimum VCSEL/PD chip count, designed for cost effective 6 fiber cable application, free from EMI interference, high bandwidth, low signal loss, which is suitable for applications such as NB docking station, high speed light weight VR headset or gaming console connection.

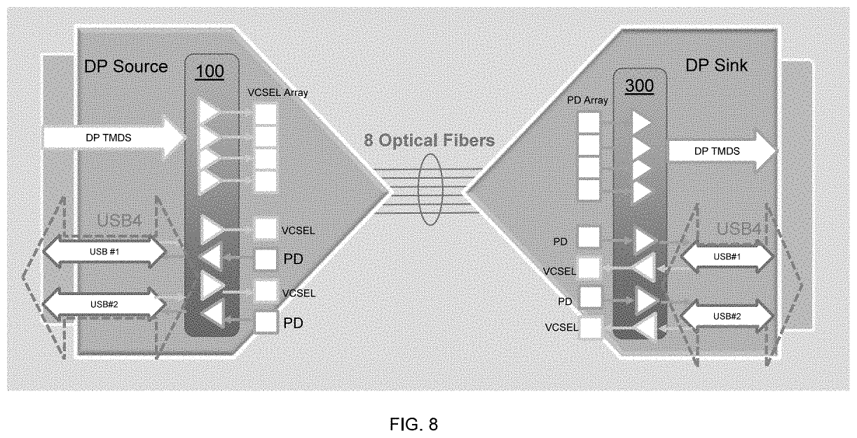

FIG. 7 illustrates an example of a communication system using the single-chip integrated circuit 100 and the single-chip integrated circuit 300, wherein the single-chip integrated circuit 100 and the single-chip integrated circuit 300 are connected by six fibers, wherein the four unidirectional channel of the single-chip integrated circuit 100 are used for transmitting HDMI TMDS video, and the four unidirectional channel of the single-chip integrated circuit 300 are used for receiving the HDMI TMDS video. Two USB bidirectional channels of the single-chip integrated circuit 100 and the two USB bidirectional channel of the single-chip integrated circuit 300 are used for transmitting and receiving control data associated with the HDMI TMDS video data. The four HDMI TMDS unidirectional channels can be 4×6 Gbps (HDMI 2.0) or 4×12 Gbps (HDMI 2.1). The two USB bidirectional channels can be 2×480 Mbps (USB 2) or 2×10 G bps (USB 3) or 2×20 G bps (USB 4). The advantages of the communication system in FIG. 8 includes: low cost AOC with minimum VCSEL/PD chip count, designed for cost effective 8 fiber cable application, free from EMI interference, high bandwidth, low signal loss, which is suitable for applications such as NB docking station, high speed light weight VR headset or gaming console connection.

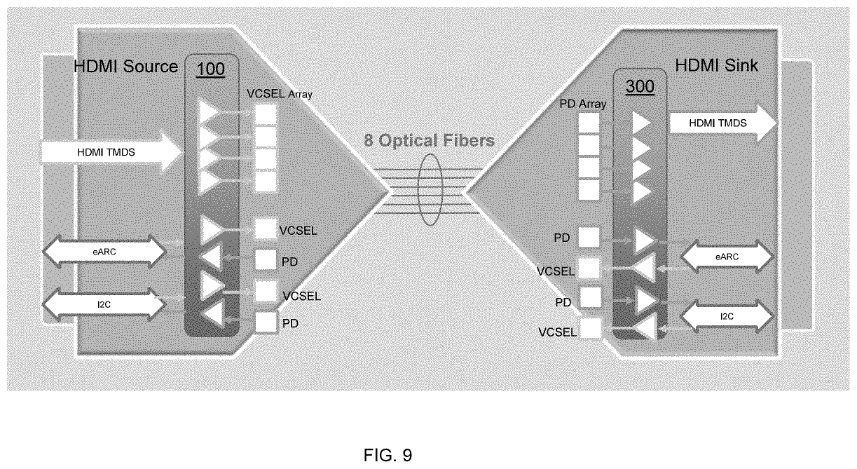

FIG. 8 illustrates an example of a communication system using the single-chip integrated circuit 100 and the single-chip integrated circuit 300, wherein the single-chip integrated circuit 100 and the single-chip integrated circuit 300 are connected by six fibers, wherein the four unidirectional channel of the single-chip integrated circuit 100 are used for transmitting DP TMDS video, and the four unidirectional channel of the single-chip integrated circuit 300 are used for receiving the DP TMDS video. Two USB bidirectional channels of the single-chip integrated circuit 100 and the two USB bidirectional channel of the single-chip integrated circuit 300 are used for transmitting and receiving control data associated with the DP TMDS video data. The four DP TMDS unidirectional channels can be 4×8.1 Gbps (DP1.4) or 4×20 Gbps (DP2.0). The two USB bidirectional channels can be 2×480 Mbps (USB 2) or 2×10 G bps (USB 3) or 2×20 G bps (USB 4). The advantages of the communication system in FIG. 9 includes: low cost AOC with minimum VCSEL/PD chip count, designed for cost effective 8 fiber cable application, free from EMI interference, high bandwidth, low signal loss, which is suitable for applications such as NB docking station, high speed light weight VR headset or gaming console connection.

FIG. 9 illustrates an example of a communication system using the single-chip integrated circuit 100 and the single-chip integrated circuit 300, wherein the single-chip integrated circuit 100 and the single-chip integrated circuit 300 are connected by six fibers, wherein the four unidirectional channel of the single-chip integrated circuit 100 are used for transmitting HDMI TMDS video, and the four unidirectional channel of the single-chip integrated circuit 300 are used for receiving the HDMI TMDS video. Two USB bidirectional channels of the single-chip integrated circuit 100 and the two USB bidirectional channel of the single-chip integrated circuit 300 are used for transmitting and receiving control data associated with the HDMI TMDS video data. The four HDMI TMDS unidirectional channels can be 4×6 Gbps (HDMI 2.0) or 4×12 Gbps (HDMI 2.1). The two bidirectional channels includes one eARC bidirectional channel and one I2C bidirectional channel. The eARC bidirectional channel can be used for HDMI 2.1 eARC reverse audio signal transmission. The I2C bidirectional channel can be used for HDMI 2.1 I2C data transmission. The advantages of the communication system in FIG. 10 includes: low cost AOC with minimum VCSEL/PD chip count, designed for cost effective 8 fiber cable application, free from EMI interference, high bandwidth, low signal loss, which is suitable for optical HDMI 2.1 AOC application.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. a single-chip integrated circuit with asymmetric optical communication architecture, comprising: at least one first unidirectional communication channel, wherein the first unidirectional communication channel comprises a first sub-circuit for converting a first electrical signal to a first optical signal; and at least one first bidirectional communication channel, wherein the first bidirectional communication channel comprises a second sub-circuit for converting a second electrical signal to a second optical signal and a third sub-circuit for converting a third optical signal to a third electrical signal.

2. The single-chip integrated circuit of claim 1, wherein the first unidirectional communication channel is used for transmitting video data and the first bidirectional communication channel is used for transmitting and receiving control data associated with the video data.

3. The single-chip integrated circuit of claim 1, wherein the first sub-circuit comprises a first equalizer and a first output driver, wherein the first electrical signal is coupled to an input of the first equalizer and an output of the first equalizer is coupled to an input of the first output driver, wherein the first output driver is coupled to a first optical diode to generate the first optical signal.

4. The single-chip integrated circuit of claim 1, wherein the second sub-circuit comprises a second equalizer and a second output driver, wherein the second electrical signal is coupled to an input of the second equalizer and an output of the second equalizer is coupled to an input of the second output driver, wherein the second output driver is coupled to a second optical diode to generate the second optical signal.

5. The single-chip integrated circuit of claim 1, wherein the third sub-circuit comprises an amplifier, wherein an input of the amplifier is coupled to a photo diode that generates a fourth electrical signal in response to the third optical signal, wherein the input of the amplifier is coupled to the fourth electrical signal and an output of the amplifier is coupled to the third electrical signal.

6. The single-chip integrated circuit of claim 1, wherein the first electrical signals is a pair of differential signals.

7. The single-chip integrated circuit of claim 1, wherein each of the second electrical signal and the third electrical signal is a pair of differential signals.

8. The single-chip integrated circuit of claim 1, wherein the at least one unidirectional communication channel is used for transmitting HDMI video data and the at least one bidirectional communication channel is used for transmitting and receiving control data associated with the HDMI video data.

9. The single-chip integrated circuit of claim 1, wherein the at least one unidirectional communication channel is used for transmitting DP video data and the at least one bidirectional communication channel is used for transmitting and receiving control data associated with the DP video data.

10. The single-chip integrated circuit of claim 1, wherein each of the second electrical signal and third electrical signal is based on USB standard.

11. The single-chip integrated circuit of claim 1, wherein the single-chip integrated circuit is based on CMOS technology.

12. The single-chip integrated circuit of claim 1, wherein the single-chip integrated circuit comprises a plurality of unidirectional communication channels and a plurality of bidirectional communication channels, wherein each unidirectional communication channel comprises a corresponding sub-circuit for converting a corresponding electrical signal to a corresponding optical signal, and wherein each bidirectional communication channel comprises a corresponding sub-circuit for converting a corresponding electrical signal to a corresponding optical signal and a corresponding third sub-circuit for converting a corresponding optical signal to a corresponding electrical signal.

13. A single-chip integrated circuit with asymmetric optical communication architecture, comprising:
at least one first unidirectional communication channel, wherein the first unidirectional communication channel comprises a first sub-circuit for converting a first optical signal to a first electrical signal; and
at least one first bidirectional communication channel, wherein the first bidirectional communication channel comprises a second sub-circuit for converting a second electrical signal to a second optical signal and a third sub-circuit for converting a third optical signal to a third electrical signal.

14. The single-chip integrated circuit of claim 13, wherein the first unidirectional communication channel is used for receiving video data and the first bidirectional communication channel is used for transmitting and receiving control data associated with the video data.

15. The single-chip integrated circuit of claim 13, wherein the first unidirectional communication channel is used for transmitting HDMI video data and the first bidirectional communication channel is used for transmitting and receiving control data associated with the HDMI video data.

16. The single-chip integrated circuit of claim 13, wherein the first unidirectional communication channel is used for transmitting DP video data and the first bidirectional communication channel is used for transmitting and receiving control data associated with the DP video data.

17. The single-chip integrated circuit of claim 13, wherein each of the second electrical signal and third electrical signal is based on USB standard.

18. The single-chip integrated circuit of claim 13, wherein the single-chip integrated circuit is based on CMOS technology.

19. A circuit with asymmetric optical communication architecture, comprising: at least one first unidirectional communication channel, wherein the first unidirectional communication channel comprises a first sub-circuit for converting a first electrical signal to a first optical signal; and at least one first bidirectional communication channel, wherein the first bidirectional communication channel comprises a second sub-circuit for converting a second electrical signal to a second optical signal and a third sub-circuit for converting a third optical signal to a third electrical signal, wherein the first unidirectional communication channel is used for transmitting video data and the first bidirectional communication channel is used for transmitting and receiving control data associated with the video data.

20. The circuit of claim 19, wherein the first unidirectional communication channel is used for transmitting HDMI video data and the first bidirectional communication channel is used for transmitting and receiving control data associated with the HDMI video data.
